(19) United States
(12) Patent Application Publication
(10) Pub. No.: US 2010/0269711 A1
(43) Pub. Date: Oct. 28, 2010

(54) Extending the Uses of Flexible Forms

(76) Inventors: Sari Klein, Shearey Tikva (IL); Sagi Yaacobi, Rehovot (IL)

Correspondence Address: The Law Office of Michael E. Kondoudis, 888 16th Street, N.W., Suite 800, Washington, DC, 20006, US

(21) Appl. No.: 12/428,555

(22) Filed: Apr. 23, 2009

(51) Int. Cl. A47J 37/06

(52) U.S. Cl. 99/357

(57) ABSTRACT

A device for extending the uses of a flexible form. One device comprises a base and handles. The handles are connected to the base to form a frame, and the frame is arranged to receive the flexible form and allow lifting the flexible form by the handles. One device further comprises a cover configured to fit onto the flexible form and to the frame and to support additional forms placed upon the cover. One device further comprises a grill configured to fit onto the flexible form and to the frame, and configured to allow grilling food thereupon. Multiple device with forms may be connected to each other.

### BACKGROUND

1. Technical Field

The present invention relates to the field of cooking devices, and more particularly, to a cooking device based on flexible forms.

2. Discussion of Related Art

Flexible forms are very useful, yet their flexibility does not allow using flexible forms for a wide array of applications.

### BRIEF SUMMARY

Embodiments of the present invention provide a device for extending the uses of a flexible form. One device comprises a base; and a plurality of handles. The handles are connected to the base to form a frame, and the frame is arranged to receive the flexible form and allow lifting the flexible form by the handles.

Accordingly, according to an aspect of the present invention, there is provided a device, further comprising a cover configured to fit onto the flexible form and to the frame and to support additional forms placed upon the cover.

According to another aspect of the present invention, there is provided a device, further comprising a grill configured to fit onto the flexible form and to the frame, and configured to allow grilling food thereupon.

Embodiments of the present invention provide a cooking kit comprising a plurality of flexible forms; a plurality of frames comprising a plurality of handles, configured to be attachable to each other, each frame configured to hold at least one flexible form; and a plurality of covers, each cover configured to fit onto at least one of the flexible forms and to at least one of the frames and to support additional forms placed upon the cover. One cooking kit allows various cooking possibilities.

Accordingly, according to an aspect of the present invention, there is provided a cooking kit, further comprising a grill configured to fit onto at least one of the flexible forms and to at least one of the frames.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a high level schematic illustration of a device for extending the uses of a flexible form, according to some embodiments of the invention;

FIG. 2 is a high level schematic illustration of a cooking apparatus, according to some embodiments of the invention;

FIGS. 3A, 3B, 3C and 3D are high level schematic illustrations of a cooking apparatus, according to some embodiments of the invention; and

FIG. 4 is a high level schematic illustration of a cooking kit, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

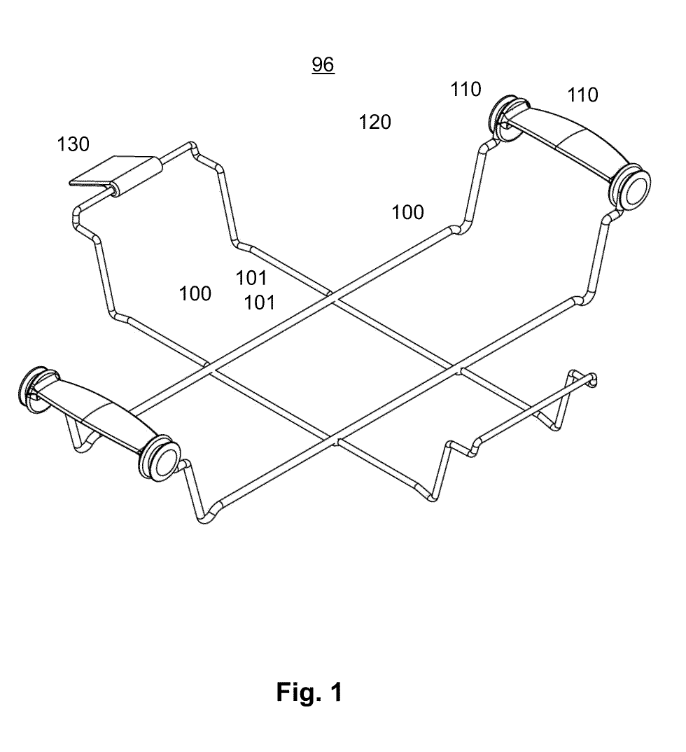

FIG. 1 is a high level schematic illustration of a device 96 for extending the uses of a flexible form, according to some embodiments of the invention. Device 96 comprises a base 100 that may comprise a set of rigid wires, and handles 110. Base 100 may comprise even or slanted wires 101, and may be produced by connecting wires in various manners, e.g., welding. Handles 110 are connected to base 100 to form a frame 120 arranged to receive the flexible form and allow lifting the flexible form by handles 100. Device 96 may further comprise a tab 130 connected to frame 120 and configured to allow pulling frame 120 with the flexible form out of an oven (before holding frame 120 by handles 110 is possible).

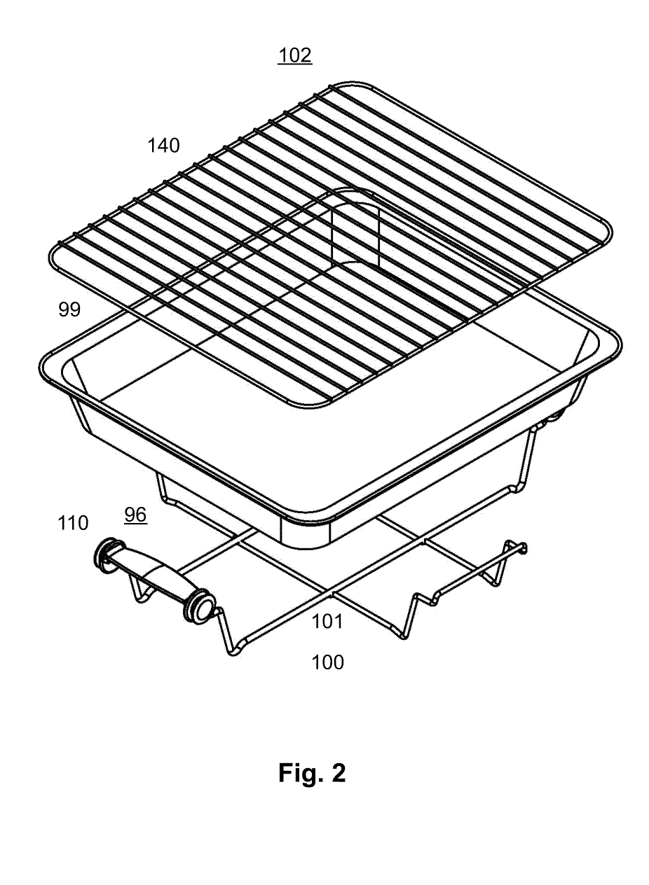

FIG. 2 is a high level schematic illustration of a cooking apparatus 102, according to some embodiments of the invention. Apparatus 102 comprises a flexible form 99, device 96 and a grill 140 allowing placing food thereupon. Device 96 comprises base 100 that may comprise a set of rigid wires 101, and handles 110. Handles 110 are connected to base 100 to form frame 120 arranged to receive flexible form 99 and allow lifting flexible form 99 by handles 110. Handles 110 may have a form that allows easy gripping and rapid cooling, for example, having a narrow cross section and a large surface area. Grill 140 is configured to fit onto flexible form 99 and to frame 120, and configured to allow grilling food thereupon.

According to some embodiments of the invention, cooking apparatus 102 may be used in various ways for cooking food. Cooking apparatus 102 may be used in an oven, wherein flexible form 99 functions as a fluid container for water or dripping fat, or it may be used as a grilling apparatus, in which flexible form 99 functions as a container for coal.

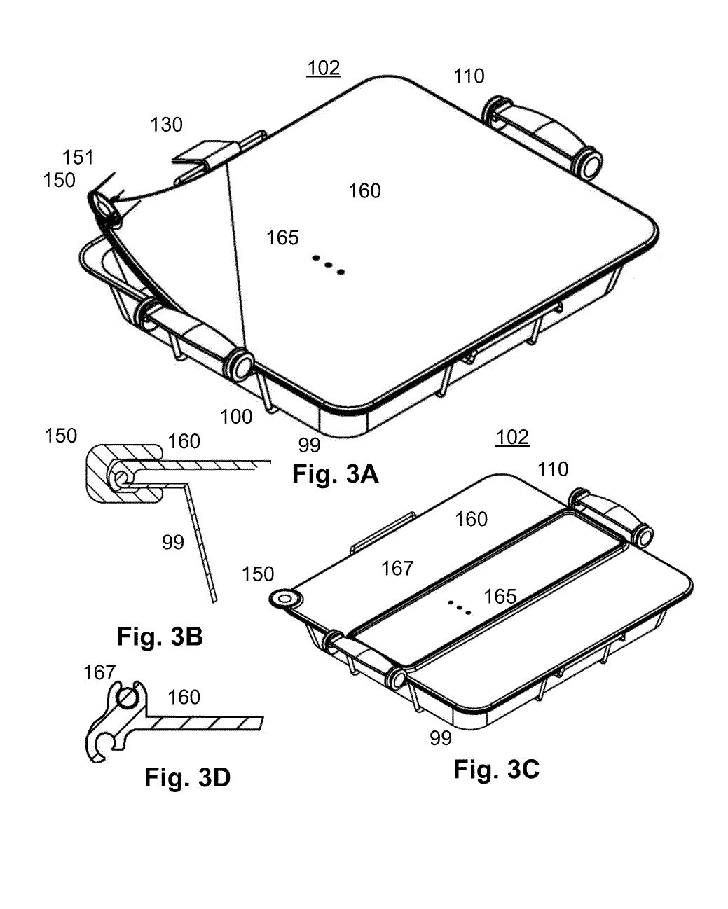

FIGS. 3A, 3B, 3C and 3D are high level schematic illustrations of a cooking apparatus 102, according to some embodiments of the invention. Cooking apparatus 102 comprises a flexible form 99 and a device comprising base 100 and handles 110 (FIG. 3A). Handles 110 are connected to base 100 to form frame 120 (see FIG. 1) arranged to receive flexible form 99 and allow lifting flexible form 99 by handles 110. Base 100 may comprise a wire 101 grid. Cooking apparatus 102 may further comprise a cover 160 configured to fit onto flexible form 99 and to frame 120 and to support additional forms 99 placed upon cover 160.

According to some embodiments of the invention, cover 160 may comprise a plastic cover with a predefined cross section selected to provide strength to the plastic cover. For example, cover 160 may exhibit a wave cross-section or a three dimensional structure configured to enhance its rigidity. According to some embodiments of the invention, tab 130 may be configured to prevent sliding of cover 160 off flexible form 99.

According to some embodiments of the invention, cover 160 may comprise a sealable silicone cover. Cover 160 may comprise a sealing element 150 configured to enable sealing cover 160 onto flexible form 99 (FIG. 3B). Sealing element 150 or cover 160 may further comprise a lug 151 (FIG. 3A), allowing opening cover 160 safely. Lugs 151 allow a quick removal of cover 160 during cooking, e.g., while form 99 is in an oven. Sealing element 150 may be snap closed upon either form 99 or frame 120. Sealing element 150 may comprise a zipper mechanism (not shown) for facilitating sealing cover 160 upon flexible form 99. Another sealing element 167 may be connectable to handles 110 and placed upon cover 160 (FIG. 3C) to prohibit its accidental opening. Sealing element 167 may also support further forms place upon it. Sealing element 167 may fit into a reel in cover 160 (FIG. 3D) and prevent cover 160 from slipping out of place.

According to some embodiments of the invention, cover 160 may comprise openings 165 arranged to allow steam out of the covered form 99. Cover 160 may serve various purposes such as protecting food in form 99, preventing spillage, supporting additional forms 99 placed upon the covered form 99, isolating used coal, effecting cooking by regulating steam pressure and so forth.

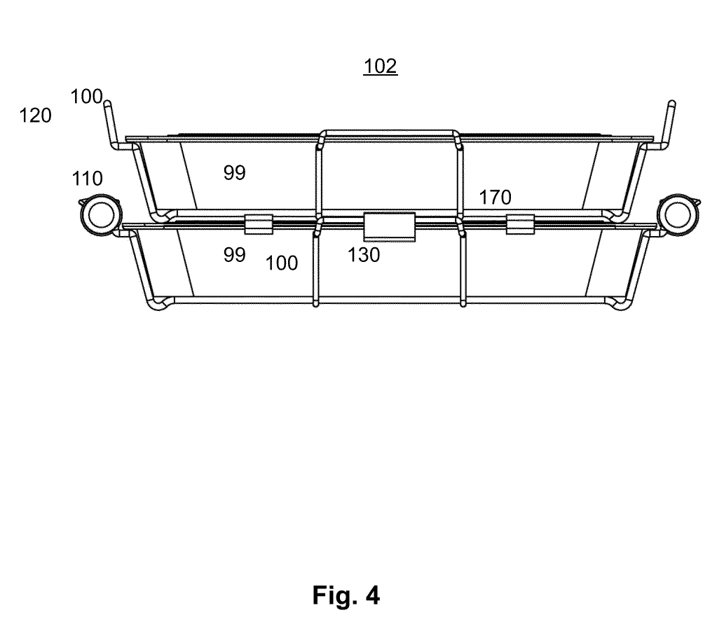

FIG. 4 is a high level schematic illustration of a cooking kit 102, according to some embodiments of the invention. Cooking kit 102 may comprise flexible forms 99 and frames 120 each comprising bases 100 and handles 110. Frames 120 are configured to be attachable to each other, and each frame 120 is configured to hold at least one flexible form 99. Further, the cooking kit may comprise covers 160, each configured to fit onto at least one of flexible forms 99 and to at least one of frames 120, and to support additional forms 99 placed upon cover 160. Covers 160 may be attached to either frames 120, flexible forms 99 or both by supporting elements 170, that may also contribute to the stability of cooking kit 102. Cooking kit 102 may further comprise tabs 130 connected to frame 120 and configured to allow pulling cooking kit 102 out of an oven. Cooking kit 102 allows various cooking possibilities such as oven cooking, backing, grilling, simmering, smoking, stewing, frying, and so on.

According to some embodiments of the invention, cooking kit 102 may further comprise grill 140 configured to fit onto at least one of flexible forms 99 and to at least one of frames 120 and allow cooking food thereupon.

According to some embodiments of the invention, flexible form 99 may comprise any type of disposable or multiple use forms 96, made of any material such as paperboard, aluminum, silicone, plastic, and so forth. Flexible form 99 may be of any form. Frame 120 may be configure to receive predefined forms, or may be arranged to be adjustable to a range of forms.

According to some embodiments of the invention, handles 110 may comprise any material, for example silicone. Handles 110 may be connected to form 120 in any method, for example gluing, attaching, overmolding and so forth.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A device for extending the uses of a flexible form comprising:
a base; and
a plurality of handles,
wherein the handles are connected to the base to form a frame, and
wherein the frame is arranged to receive the flexible form and allow lifting the flexible form by the handles.

2. The device of claim 1, further comprising a cover configured to fit onto the flexible form and to the frame and to support additional forms placed upon the cover.

3. The device of claim 2, wherein the cover is a plastic cover with a predefined cross section selected to provide strength to the plastic cover.

4. The device of claim 2, wherein the cover is a sealable silicone cover.

5. The device of claim 4, further comprising a sealing element configured to enable sealing the sealable silicone cover onto the flexible form.

6. The device of claim 2, wherein the cover further comprises at least one lug, allowing opening the cover safely.

7. The device of claim 2, wherein the cover further comprises a plurality of openings arranged to allow steam out of the covered form.

8. The device of claim 2, wherein the cover exhibits a three dimensional structure configured to enhance its rigidity.

9. The device of claim 2, further comprising at least one tab connected to the frame and configured to prevent sliding of the cover off the flexible form.

10. The device of claim 1, wherein the base comprises a rigid wire mesh.

11. The device of claim 1, wherein the handles are configured to cool rapidly.

12. The device of claim 1, further comprising a grill configured to fit onto the flexible form and to the frame, and configured to allow grilling food thereupon.

13. The device of claim 1, further comprising at least one tab connected to the frame and configured to allow pulling the frame with the flexible form out of an oven.

14. A cooking kit comprising:
a plurality of flexible forms;
a plurality of frames comprising a plurality of handles, configured to be attachable to each other, each frame configured to hold at least one flexible form; and
a plurality of covers, each cover configured to fit onto at least one of the flexible forms and to at least one of the frames and to support additional forms placed upon the cover,
wherein the cooking kit allows various cooking possibilities.

15. The cooking kit of claim 14, further comprising a grill configured to fit onto at least one of the flexible forms and to at least one of the frames.

16. The cooking kit of claim 14, further comprising a plurality of supporting elements configured to be attachable to the cooking kit and to contribute to the stability of the cooking kit.
